(19) United States
(12) Patent Application Publication
(10) Pub. No.: US 2023/0184380 A1
(43) Pub. Date: Jun. 15, 2023

(54) FUEL-GAS SUPPLY SYSTEM AND METHOD FOR SUPPLYING A HIGH-PRESSURE GAS INJECTION ENGINE WITH FUEL GAS

(71) Applicant: BURCKHARDT COMPRESSION AG, Winterthur (CH)

(72) Inventor: Roman SCHROTH, Winterthur (CH)

(73) Assignee: BURCKHARDT COMPRESSION AG, Winterthur (CH)

(21) Appl. No.: 17/925,424

(22) PCT Filed: May 18, 2021
(86) PCT No.: PCT/EP2021/063141

§ 371 Date: Nov. 15, 2022

(30) Foreign Application Priority Data
May 19, 2020 (EP) 20175575.8
May 20, 2020 (EP) 20175873.7

(51) Int. Cl. F17C 1/12

(52) U.S. Cl. CPC F17C 1/12

(57) ABSTRACT

Fuel gas supply system for supplying a high-pressure gas injection engine with gas stored in a liquefied gas tank, preferably an LNG tank, having a high-pressure pump to which liquefied gas is supplied. The system including a condenser with a high-pressure heat exchanger, a high-pressure vaporizer which is connected to the high-pressure pump via the high-pressure heat exchanger and is arranged downstream of the condenser. Gas fed to the high-pressure gas injection engine downstream of the high-pressure evaporator. A compressor to which boil-off gas is fed is connected downstream to the condenser via an inlet. A condensation core generator to which liquid gas is supplied from the high-pressure pump in such a manner that the condensation nuclei generated by the condensation nucleus generator promote condensation of the supplied boil-off gas. The liquid gas formed in the condenser is supplied to the high-pressure pump and/or to the liquid gas tank.

The invention relates to a fuel gas supply system. The invention further relates to a method of supplying fuel gas to a high pressure gas injection engine.

### STATE OF THE ART

Natural gas is an energy source that is becoming increasingly important. In merchant shipping, natural gas is increasingly being used as an alternative fuel to meet the newly applicable requirements for the shipping industry regarding boil-off gas purity and greenhouse gas reduction. Natural gas used as a fuel is typically stored on ships in liquid form as liquefied natural gas, or LNG for short, and in LNG tanks at approximately atmospheric pressure and a temperature of about -163° C. Due to the low boiling temperature of the liquefied natural gas of about -162° C. at atmospheric pressure, the heat acting on the LNG tanks from outside continuously vaporizes liquid gas, which accumulates at the top of the LNG tank as boil-off gas (BOG), causing a pressure increase in the LNG tank. To counteract this pressure increase, it is known to provide a BOG reliquefaction plant, which liquefies the boil-off gas and feeds it back to the LNG tank as liquefied gas. Another possibility is to use the boil-off gas directly as a ship propulsion fuel. For this purpose, natural gas is compressed to a high pressure in the range of, for example, 150 to 300 bara or 400 bara to form high-pressure fuel gas and fed to a high-pressure gas injection engine. Such an engine is marketed, for example, by the MAN-SE company under the designation ME-GI engine. Such an engine preferably forms the main propulsion system of a merchant ship.

Document KR 10 2011 0030149 discloses a fuel gas supply system for supplying fuel gas to a high-pressure gas injection engine of a liquefied natural gas tanker. This system is capable, on the one hand, of compressing natural gas stored in the LNG tank to such a high pressure that it can be supplied to the high-pressure gas injection engine and, on the other hand, is capable of preventing an excessive pressure rise in the LNG tank by rel-iquefying, if necessary, boil-off gas and subsequently supplying it to the high-pressure gas injection engine and/or the LNG tank. The fuel gas supply system disclosed in document KR1020110030149 has the disadvantages of being relatively complex and expensive, using an external cooling circuit for reliquefaction, and requiring a significant amount of energy to operate.

Document KR 100 726 290 shows a method for recycling excess vaporization gas by controlling the liquefaction, reliquefaction, or utilization of the vaporization gas. The method includes the steps of liquefying the vaporization gas, selectively returning liquefied gas to a gas storage tank, or selectively supplying the liquefied gas to a liquefied gas vaporizer through first and second control valves. A predetermined amount of the liquefied gas is vaporized in the liquefied gas vaporizer so that it is suitable for delivery as a fuel by controlling the temperature, pressure, and flow. Further, the method comprises supplying the vaporized gas as a fuel of a propulsion system and retrieving the liquefied vaporized gas or opening/closing the first, second, third, and fourth valve to burn a small amount of the vaporized gas. In this system, the specific heat capacity of injected subcooled LNG is used to reliquefy BOG. However, it is a low-pressure system and is not suitable for supplying fuel gas to a high-pressure gas injection engine.

### Description of the Invention

It is a task of the invention to form an economically more advantageous fuel gas supply system. Furthermore, it is the task of the invention to form an economically more advantageous method for supplying a high-pressure gas injection engine with fuel gas. This task is solved with a fuel gas supply system having the features of claim 1. Dependent claims 2 to 11 concern further advantageous embodiments. The task is further solved with a method comprising the features of claim 12. The dependent claims 13 to 18 concern further, advantageous method steps.

The task is solved in particular with a fuel gas supply system for supplying a high-pressure gas injection engine with gas stored in a liquefied gas tank, in particular an LNG tank, comprising a high-pressure pump which can be connected in a fluid-conducting manner to the liquefied gas tank, preferably via a low-pressure pump, in order to supply liquefied gas from the liquefied gas tank and to compress it into a high-pressure liquefied gas, respectively to provide it as a high-pressure liquid gas, comprising a condenser in which a high-pressure heat exchanger is arranged, comprising a high-pressure evaporator which is fluid-conductively connected to the high-pressure pump via the high-pressure heat exchanger and is arranged downstream of the condenser, the high-pressure evaporator converting the high-pressure liquid gas into a high-pressure fuel gas and the high-pressure fuel gas being fed to the high-pressure gas injection engine downstream of the high-pressure evaporator, comprising a compressor fluid-conductively connectable to the liquid gas tank for supplying boil-off gas from the liquid gas tank, the compressor being fluid-conductively connected to an inner space of the downstream condenser via an inlet for introducing the boil-off gas into the inner space, and comprising a condensing core generator fluid-conductively connected to the high-pressure pump upstream, the condensing core generator being configured such that it t generates liquid gas droplets from the high-pressure liquid gas, which droplets serve as condensation nuclei, the condensation nucleus generator introducing the condensation nuclei into the inner space in order to promote condensation of the introduced boil-off gas via the condensation nuclei, so that liquid gas is formed therefrom, and that the liquid gas formed in the condenser is fed to the high-pressure pump and/or the liquid gas tank.

The task is in particular also solved with a fuel gas supply system for supplying a high-pressure gas injection engine with gas stored in a liquefied gas tank, comprising a high-pressure pump to which liquefied gas is supplied from the liquefied gas tank, comprising a condenser in which a high-pressure heat exchanger is arranged, comprising a high-pressure evaporator which is connected to the high-pressure pump via the high-pressure heat exchanger and is arranged downstream of the condenser, the gas being fed to the high-pressure gas injection engine after the high-pressure evaporator, comprising a compressor to which boil-off gas is fed from the liquefied gas tank, the compressor being connected downstream via an inlet to the condenser to introduce the boil-off gas into the condenser, and comprising a condensation core generator to which liquid gas is supplied from the high pressure pump, the condensation core generator and the inlet being arranged in the condenser to cooperate in such a manner that the condensation nuclei generated by the condensation nucleus generator promote condensation of the supplied boil-off gas in the condenser so that liquefied gas is formed therefrom, and that the liquefied gas formed in the condenser is supplied to the high-pressure pump and/or the liquefied gas tank.

The task is solved in particular with a method for supplying a high-pressure gas injection engine with gas, the gas being stored in a liquefied gas tank partly as liquefied gas and partly as evaporated gas, in that the liquefied gas is fed from the liquefied gas tank to a high-pressure pump and is compressed by the latter to a high-pressure liquefied gas, the high-pressure liquid gas then being fed to a high-pressure heat exchanger arranged in a condenser and subsequently to a high-pressure evaporator, the high-pressure liquid gas being converted into a high-pressure fuel gas in the high-pressure evaporator, so that a high-pressure fuel gas is produced, which is fed to the high-pressure gas injection engine, in that the boil-off gas from the liquefied gas tank is fed to a compressor and then introduced into the condenser, wherein a stream of condensation nuclei in the form of liquefied gas droplets is produced from high-pressure liquefied gas in a condensation nucleus generator, which are fed to the introduced boil-off gas in the condenser in order to promote condensation of the boil-off gas into liquefied gas by means of the liquefied gas droplets, and in that the liquefied gas formed in the condenser is fed to the high-pressure pump and/or the liquefied gas tank.

Furthermore, the task is also solved in particular with a method for supplying a high-pressure gas injection engine with fuel gas which is stored in a liquefied gas tank partly as liquefied gas and partly as exhaust vapor gas, in that the liquefied gas is fed from the liquefied gas tank to a high-pressure pump, then to a high-pressure heat exchanger arranged in a condenser, and subsequently to a high-pressure evaporator, so that a high-pressure fuel gas is produced which is fed to the high-pressure gas injection engine, in that the boil-off gas is fed to a compressor and subsequently introduced into the condenser, and in that, in the condenser, condensation nuclei are fed to the introduced boil-off gas in order to promote condensation of the boil-off gas to liquid gas, and in that the liquid gas formed in the condenser is fed to the high-pressure pump and/or to the liquid gas tank.

The fuel gas supply system according to the invention uses a condenser to condense boil-off gas into liquid gas. For this purpose, condensation nuclei are generated from liquid gas with the aid of a condensation nucleus generator, which inside the condenser come into contact with boil-off gas located in an inner space of the condenser, so that the boil-off gas adheres to the condensation nuclei and thereby condenses to liquid gas. The condensation nuclei are preferably generated by means of high-pressure liquid gas which is passed through a nozzle, in particular a spray nozzle, so that a plurality of liquid droplets which serve as condensation nuclei are generated by means of the nozzle. The fuel gas supply system according to the invention has the advantages that the condensation takes place at a relatively low pressure, for LNG for example at a pressure in the range of below 50 bara, preferably in a range of 20 to 30 bara, and particularly preferably in a range of 10 to 20 bara, and that a condensate or liquid gas is produced with a relatively low temperature, for example with a temperature of below -120° C., and preferably in the range -120° C. and -150° C. A pressure below 20 bara has the advantage that a two-stage compressor is sufficient to compress the boil-off gas F2 in the compressor 9. For a pressure in the range between 40 and 50 bara, a three-stage compressor 9 is required. For cost reasons, a two-stage compressor 9 or compression of the exhaust steam gas F2 in a range of 10 to 20 bara is particularly preferred. The relatively low pressure inside the condenser during condensation requires a lower specific enthalpy for the compression process of the boil-off gas upstream of the condenser, which takes place before the boil-off gas is fed to the condenser. This results in the advantage that a smaller and thus less expensive compressor is sufficient for this compression process. The lower temperature of the condensate, if the condensate is subsequently fed to a high-pressure pump, also leads to reduced evaporation in the high-pressure pump, and therefore increases the mean time between maintenance of the high-pressure pump, also referred to as MTBO, so that the fuel gas supply system according to the invention can be operated more cost-effectively and reliably.

A “high-pressure pump” in the sense of the invention is understood to mean, in particular, a pump that generates pressures of at least 80 bara, preferably generates pressures of 100 to 400 bara, typically generates pressures of 150 to 300 bara. It may be a positive displacement machine, for example a piston pump. A “low pressure pump”, on the other hand, is understood to mean a pump, for example a fluid machine, that generates pressures of less than 80 bara, typically pressures of 5 to 25 bara.

It is preferred that the LNG tank is an LNG tank and the fuel gas is natural gas, in particular methane. However, other fuel gases are also conceivable, in particular ethylene, ethane or ammonia. Then the system and the process would have to be operated under adapted pressure and temperature conditions. In the case of ammonia as fuel, for example, the high-pressure pump should generate a pressure of 300 to 400 bara. Such a liquid gas could be introduced as liquid gas droplets into the inner space of the condenser in a condensing section of a condenser having a temperature of -10 to +10° C. and a pressure of 5 to 10 bara.

In a preferred embodiment, it is sufficient if only a small amount of liquefied gas is injected by means of the condensation core generator, as compared to the mass flow of the gas stream to be condensed. In particular, it is sufficient if the mass flow of liquid gas (F1) in the condensation core generator is 1 to 5% of the mass flow of the gas (F2) to be condensed.

The fuel gas supply system according to the invention thus has the advantage that the reliquefaction pressure and the reliquefaction temperature of the boil-off gas to be reliquefied or the liquefied gas generated in the process are reduced.

The fuel gas supply system according to the invention has the further advantage that the compression of the boil-off gas upstream of the condenser requires a reduced specific enthalpy, so that this compressor can be designed more cost-effectively and, in addition, reduced operating expenses (OPEX), and in particular reduced energy costs, are incurred for this compressor.

The fuel gas supply system according to the invention has the further advantage that the improved condensation requires a smaller condenser design, which reduces capital expenditures (CAPEX). The heat exchanger according to the invention is a heat exchanger based on indirect heat transfer, i.e. the streams are separated by a heat-permeable wall. This makes it possible to realize a high-pressure heat exchanger in which the coolant is supplied to the cooling section at a high pressure (e.g. 80 to 300 bara) and also leaves it at essentially the same pressure. Due to the improved condensation, a high-pressure heat exchanger with a smaller heat transfer area is sufficient, so that a smaller high-pressure heat exchanger and thus a smaller condenser are required within the condenser.

The fuel gas supply system according to the invention has the further advantage that the reduced, lower temperature of the liquid gas condensed from the boil-off gas improves the performance of the high-pressure pump.

Preferably, a side stream of high-pressure liquid gas is taken from or downstream of the high-pressure pump. Advantageously, this side stream of high-pressure liquid gas is cooled in a heat exchanger, with boil-off gas from the liquid gas tank being fed to this heat exchanger. Advantageously, the condenser for condensing the boil-off gas comprises a condensation nucleus generator or an injector system for droplet generation, to which the supercooled high-pressure liquid gas is fed in order to generate condensation nuclei or aerosol droplets and to introduce them into the inner space of the condenser or to spray them in the inner space of the condenser, the condensation nuclei serving to improve condensation of the exhaust gas. The LNG is injected with special nozzles that ensure the correct droplet size, so that these LNG droplets can serve as condensation nuclei. A physical surface effect, a curvature effect, or interface effect, also known as the Gibbs-Thomson effect, is used in this process. The technical principles are known from the fields of nanotechnology and aerosol technology. It is preferred that the nozzle is a high-pressure nozzle, especially preferred a high-pressure nozzle with nozzle diameter in the range of 1 to 1000 µm, preferably 5 to 500 µm. Such a high-pressure nozzle is suitable for producing droplets in the relevant range, typically droplets with a diameter of 100 nm to 100 µm, preferably 500 nm to 50 µm.

In a preferred embodiment, the boil-off gas (F2) is introduced into the condenser from above, with the high-pressure heat exchanger extending vertically inside the condenser and the high-pressure heat exchanger being arranged in such a way that the high-pressure liquid gas in the high-pressure heat exchanger flows from the bottom to the top. This supports the natural temperature gradient inside the condenser. Preferably, the condensation nucleus generator is arranged such that condensation nuclei generated by the condensation nucleus generator are introduced into the interior space of the condenser in a condensation section in which the interior space has a condensation temperature. For example, at a pressure of 17 bara, the boiling temperature of natural gas is about -110° C. To achieve complete reliquefaction of the boil-off gas F2 in the condenser, the actual condensation temperature would have to be about -120° C. Preferably, the condensation core generator is arranged in such a way that the condensation cores enter the inner space of the condenser in a first half, preferably a first third in the flow direction of the liquid gas (F1), of the cooling line of the high-pressure heat exchanger.

The invention is described in detail below on the basis of several embodiments.

### BRIEF DESCRIPTION OF THE DRAWINGS

The drawings used to explain the embodiments show:

FIG. 1 schematically a first embodiment of a fuel gas supply system;

FIG. 2 schematically a second embodiment of a fuel gas supply system;

FIG. 3 schematically a third embodiment of a fuel gas supply system;

FIG. 4 schematically a fourth embodiment of a fuel gas supply system;

FIG. 5 schematically a fifth embodiment of a fuel gas supply system;

FIG. 6 schematically a condenser.

In principle, in the drawings the same parts are designated with the same reference numbers.

### WAYS TO CARRY OUT THE INVENTION

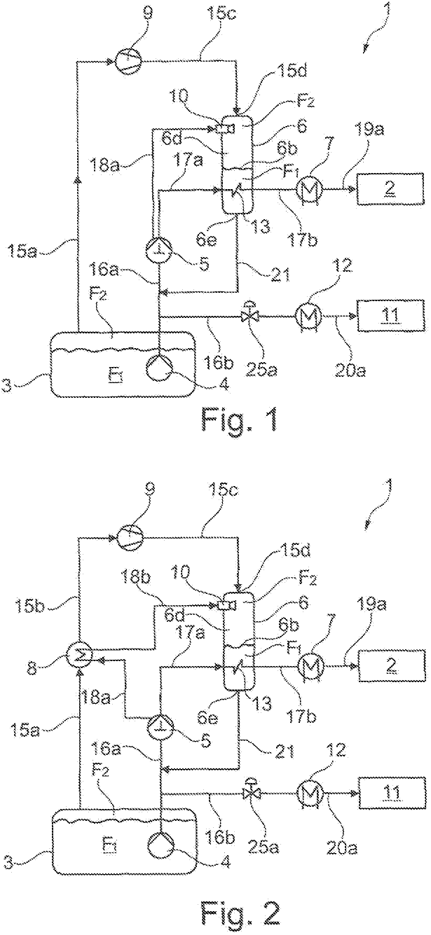

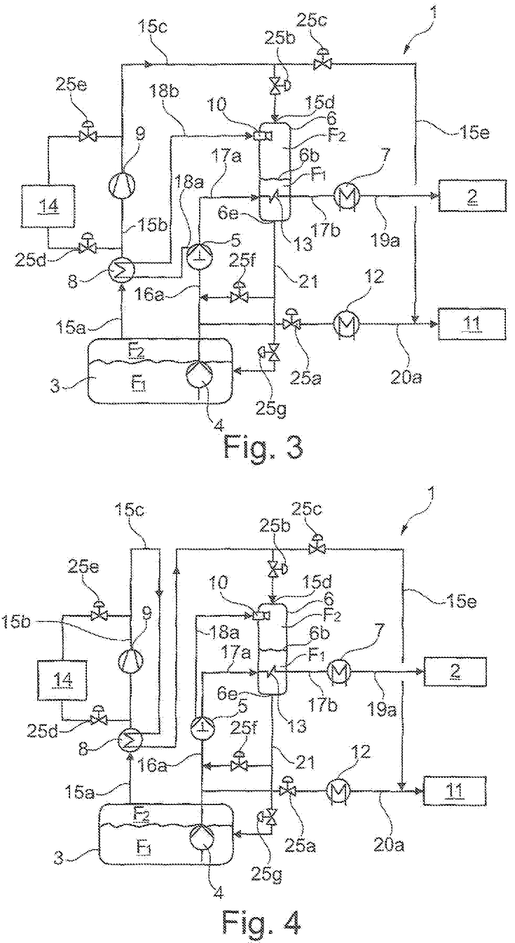

FIG. 1 shows a fuel gas supply system 1 for supplying a high-pressure gas injection engine 2, preferably an ME-GI engine, with fuel gas, preferably methane. The fuel gas is stored in an LNG tank 3, partly in the form of liquid gas F1 and, due to the vaporization of the liquid gas F1 occurring in the LNG tank 3, partly in the form of boil-off gas F2. This boil-off gas F2 is also referred to as BOG or NBOG (Natural Boil-Off Gas). To supply the high-pressure gas injection engine 2 with fuel gas at a pressure in the range of, for example, 150 to 300 bara, the liquefied gas F1 located in the LNG tank 3 is fed via a low-pressure pump 4 and a low-pressure fluid line 16a to a high-pressure pump 5, which increases the pressure of the liquefied gas F1 to a high pressure of, for example, between 150 and 300 bara. This high-pressure liquid gas is then fed via a high-pressure fluid line 17a, a high-pressure heat exchanger 13 and a high-pressure fluid line 17b to a high-pressure evaporator 7, which evaporates the high-pressure liquid gas to a gaseous or supercritical high-pressure gas, this high-pressure gas, having a pressure of about 300 bara in the embodiment shown, being fed to the high-pressure gas injection engine 2. The illustrated fuel gas supply system 1 further comprises a condenser 6 having an inner space 6d, in which liquid gas F1 and boil-off gas F2 are present at least during operation of the fuel gas supply system. The boil-off gas F2 is supplied via a gas line 15a from the LNG-tank 3 to a compressor 9, which compresses the boil-off gas F2, whereby this compressed boil-off gas F2 is fed via a gas line 15c and via a subsequent inlet 15d into the inner space 6d of the condenser 6. The fuel gas supply system 1 also comprises a condensation core generator 10, to which high-pressure liquid gas is supplied by the high-pressure pump 5 via a side stream or via the high-pressure fluid line 18a. The condensation core generator 10 and the inlet 15d are arranged in the condenser 6 to cooperate in such a way that the liquid condensation cores 10a or liquid gas droplets generated by the condensation core generator 10 and sprayed into the inner space 6d, promote condensation of the supplied boil-off gas F2 in the condenser 6, so that boil-off gas F2 accumulates on the condensation core and condenses to liquid gas F1, and then accumulates in the lower region of the condenser 6. This liquid gas F1 accumulating in the condenser 6 is fed to the high-pressure pump 5 via an outlet 6e and a return line 21, or, as shown in FIG. 3, is optionally fed to the high-pressure pump 5 and/or the LNG tank 3. The high-pressure heat exchanger 13 is arranged in or inside the condenser 6, as shown in FIG. 1, in order to cool the content of the condenser 6, in particular the boil-off gas F2 located therein, by indirect heat exchange and also to condense it. The supercritical high-pressure liquid gas flowing through the heat exchanger 13 thus has the function of a heat sink. The compressor 9 is designed, for example, as a piston compressor, for example as a labyrinth piston compressor, and for example as a two-stage or three-stage piston compressor, wherein at least one of the piston compressors, preferably the first piston compressor arranged downstream of the LNG tank 3, is designed as a labyrinth piston compressor. However, the compressor or at least one compressor stage could also be designed as a turbo compressor or in another compressor technology.

Optionally, the fuel gas supply system 1 further comprises a low-pressure fluid line 16b and a valve 25a to supply at least a partial flow of the liquid gas F1 delivered by the low-pressure pump 4 to a low-pressure vaporizer 12, which vaporizes the liquid gas F1 to gaseous low-pressure gas, having a pressure in the range of, for example, 7 to 9 bara. This low-pressure gas is fed to a low-pressure consumer 11, for example a gas-powered generator or boiler.

FIG. 6 shows an embodiment of a condenser 6 in detail, as it could be used in the fuel gas supply system 1 according to FIG. 1. The boil-off gas F2 is introduced into the inner space 6d of the condenser 6 via the gas line 15c and the inlet 15d at the top. A side stream of the high-pressure liquid gas is injected into the inner space 6d of the condenser 6 via the high-pressure line 18a and the condensation core generator 10, forming a plurality of droplets 10a serving as condensation cores. A return line 21 opens into the bottom of the inner space of the condenser 6 to discharge the liquid gas F1 located in the lower portion of the inner space. The high-pressure heat exchanger 13 extends in the inner space 6d of the condenser 6 preferably in a vertical direction from bottom to top, the high-pressure liquid gas being supplied via the high-pressure fluid line 17a and discharged via the high-pressure fluid line 17b. Advantageously, the high-pressure heat exchanger 13 as shown in FIG. 4 extends for the most part, for example 9/10, within that part of the inner space 6d in which the boil-off gas F2 or a mixture of boil-off gas F2 and droplets of liquid gas F1 is located.

During operation, the condenser 6 can be operated, for example, with the following process parameters. The high-pressure liquid gas is fed to the high-pressure heat exchanger 13 at a pressure of 300 bara, and leaves it at essentially the same pressure. The boil-off gas F1 is introduced at a pressure of 17 bara and a temperature of +40° C. via the inlet 15d from above into the inner space 6d of the condenser 6. The boil-off gas F1 flowing downward inside the condenser 6 from the inlet 15d is cooled by the high-pressure heat exchanger 13 so that a condensation section 6a is formed between the surface 6b of the liquid gas F1 and a boundary region 6c, within which the boil-off gas F2 has a temperature which, taking into account the pressure present in the inner space 6d, is below the boiling temperature of liquid gas F1. The condensation nuclei in the form of liquid gas droplets 10a generated by the condensation nucleus generator 10 are preferably sprayed into the condensation section 6a so that the boil-off gas F2 located in this section condenses on these condensation nuclei and is subsequently fed via the surface 6b to the partial volume 6e of the condenser 6 containing the liquid gas F1. The liquid gas F1 has a pressure of 17 bara and a temperature of -120° C. in the partial volume 6e in the process example described here.

The method for operating the fuel gas supply system 1 is explained in detail on the basis of the following example. In contrast to a liquefied gas tanker, the stowage space of which consists largely of LNG tanks, a common merchant ship has a relatively small LNG tank, since the stowage space is available for goods to be transported. The high-pressure gas injection engine 2 of such a merchant ship has a gas demand of, for example, about 10 t / h during the voyage. In the LNG tank of the merchant ship, the boil-off rate (BOR), therefore the amount of liquid gas F1 evaporated to boil-off gas F2 is, for example, about 800 kg / h. On the one hand, the fuel gas supply system 1 has the task of supplying the high-pressure gas injection engine 2 with a sufficiently large quantity of high-pressure fuel gas, which varies depending on the load. In addition, the fuel gas supply system 1 has the task of monitoring the gas pressure in the LNG-15 tank and ensuring that the gas pressure does not exceed a predetermined value. In addition, the fuel gas supply system 1 has the task of ensuring that the excess boil-off gas located in the LNG tank is used in an economically as well as ecologically advantageous manner, and in particular is used to feed the high-pressure gas injection engine 2, and if necessary to feed a low-pressure consumer 11.

The liquefied gas F1 in the LNG tank 3, stored at about atmospheric pressure and a temperature of about -163° C., is conveyed to the high-pressure pump 5 by means of the low-pressure pump 4, and thereby compressed to a pressure of about 7 bara, at a temperature of -150° C. In order to supply the high-pressure gas injection engine 2 with sufficient high-pressure fuel gas, the liquid gas F1 is subsequently compressed in the high-pressure pump 5 to high-pressure liquid gas to a pressure of 300 bara, at a conveying temperature of -150° C., and then vaporized in the high-pressure vaporizer 7 to gaseous or supercritical high-pressure fuel gas. The high-pressure fuel gas thus produced is supplied to the high-pressure gas injection engine 2. The quantity of high-pressure fuel gas supplied can be controlled by appropriately controlling the conveying rate of the high-pressure pump 5 and, if necessary, the low-pressure pump 4.

The boil-off gas F2 is withdrawn from the tank 3 at approximately atmospheric pressure and a temperature of about -162° C., and then compressed in a compressor 9 to a pressure of about 18 bara, with an outlet temperature of + 40° C. The boil-off gas F2 thus compressed is preferably introduced into the interior 6d of the condenser 6 at this pressure and temperature. The boil-off gas F2 compressed in this way is preferably introduced into the inner space 6d of the condenser 6 at this pressure and temperature.

As shown in FIG. 6, inside the condenser 6 the high-pressure liquid gas located in the high-pressure heat exchanger 13 flows upwardly at a pressure of 300 bara and a conveying temperature of -150° C., whereas the compressed boil-off gas F2 is introduced into the inner space 6d of the condenser 6 from above, and flows downwardly in the upper section of the condenser 6 along the high-pressure heat exchanger 13, and the compressed exhaust steam gas F2 thus flows in countercurrent with respect to the high-pressure liquid gas flowing inside the high-pressure heat exchanger 13, whereby the exhaust steam gas F2 is cooled, and preferably cooled to its condensation temperature. At a pressure of 17 bara, the boiling temperature of the boil-off gas F1 is about -110° C. In order to achieve complete reliquefaction of the exhaust steam gas F2 in the condenser 6, the high-pressure heat exchanger 13 or the high-pressure gas flowing therein must have sufficient potential to take over the enthalpy at temperatures below -110° C. Taking into account a necessary supersaturation for condensation at 17 bar, the actual condensation temperature will be about 5 to 10 K below the boiling temperature at 17 bar a, so that condensation takes place at about -120° C.

The -150° C. at which the supercritical high-pressure gas or the high-pressure liquid gas enters the high-pressure heat exchanger 13 on the high-pressure side is not directly available for heat transfer, since several temperature gradients must be taken into account for heat transfer through the supercritical high-pressure gas and the wall of the high-pressure heat exchanger 13. As a first approach, it is assumed that the wall temperature of the high pressure heat exchanger 13 on the side facing the boil-off gas F2 is -145° C. This allows enthalpy transfer from the boil-off gas F2 to the supercritical high-pressure gas or the high-pressure liquid gas in a temperature window of 25°K.

In order to increase the efficiency of reliquefaction of boil-off gas F2 to liquefied gas F1 in the condenser 6, a condensation nucleus generator 10 is used to generate liquefied gas droplets as condensation nuclei, which are fed into the interior 6d of the condenser 6. For this purpose, a portion of the liquid gas F1 compressed to high-pressure liquid gas by the high-pressure pump 5 is supplied to the condensation core generator 10 in a side stream 18a, the supplied high-pressure liquid gas having a pressure of 300 bara and a temperature of -150° C. The droplets 10a generated in the condensation core generator 10, for example with the aid of at least one nozzle, are introduced into a condensation section 6a of the condenser 6, in which the temperature of the boil-off gas F2 is already below its condensation temperature of -110° C. The liquid gas droplets 10a entering the condenser 6 are thus subcooled, since the condensation temperature of the boil-off gas F2 is 110° C. at 17 bara.

The supercooled liquid gas droplets 10a serve as condensation nuclei for the boil-off gas F2 to be condensed. That is, each supercooled liquid gas droplet 10a attracts gas molecules from the boil-off gas F2 to be condensed. Condensation of the boil-off gas F2 on the liquid gas droplets 10a is more effective than condensation on the outer wall of the high-pressure heat exchanger 13, for the following reasons:
The liquid gas droplets are supercooled at -150° C., resulting in a higher potential for attracting gas molecules of the boil-off gas F2 due to the larger temperature difference.
The specific surface area of a liquid gas droplet is larger than the comparable surface area of the outer wall of the high-pressure heat exchanger 13, since the area of a sphere is pi times larger than the area of a flat or curved surface.

FIGS. 2 and 3 show further embodiments of fuel gas supply systems 1 in which, in contrast to the embodiment according to FIG. 1, a heat exchanger 8 is arranged in the boil-off gas flow, after the boil-off gas F2 has left the LNG tank 3, which serves to further cool the high-pressure liquid gas after the high-pressure pump 5 and before it enters the condensation core generator 10. As a result, the boil-off gas F2 flowing in the fluid line 15a, 15b is heated in the heat exchanger 8. The heat exchanger 8 is preferably supplied by a side stream 18a of the high-pressure fluid gas, wherein the side stream 18a is taken from the high-pressure pump 5 or downstream of the high-pressure pump 5 from the high-pressure fluid line 17a, is supplied to the heat exchanger 8, and is subsequently preferably supplied to the condensation core generator 10. The heat exchanger 8 is preferably arranged upstream of the compressor 9, as shown in FIG. 2.

For the fuel gas supply system 1 according to the invention, it is important that the condensation of the boil-off gas F2 supplied to the condenser 6, as shown in FIG. 6, in the inner space 6d of the condenser 6 preferably takes place as energy-efficiently as possible. It is generally known to a person skilled in the art that the fuel gas supply system 1 shown in FIGS. 1 to 5 comprises a control device not shown, as well as a plurality of signal lines, for example for controlling the low-pressure pump 4, the high-pressure pump 5, the compressor 9, and the valves 25a to 25g, and comprises a plurality of signal lines as well as sensors, for example for detecting pressure and / or temperature at a wide variety of points at which the liquid gas F1 and boil-off gas F2, as well as high-pressure liquid gas and high-pressure fuel gas, flows through the fuel gas supply system 1. It is therefore easy for a person skilled in the art to understand, on the basis of the present disclosure, which control options and which parameter optimizations the fuel gas supply system 1 according to the invention offers in order to operate the fuel gas supply system 1 according to the invention advantageously, and in particular in order to ensure that the condensation in the condenser 6 proceeds advantageously, preferably energy-efficiently. Thus, for example, it can be derived in a simple manner from FIG. 1 that the condensation of the boil-off gas F2 in the condenser 6 is effected by means of the delivery rate of boil-off gas F2 delivered by the compressor 9, and if necessary also its temperature, and/or by means of the conveying rate of high-pressure liquid gas supplied by the side stream 18a, 18b to the condensation core generator 10, and in particular also its temperature, and/or by the size and quantity of condensation nuclei 10a produced by the condensation nucleus generator 10, and/or by the arrangement and orientation of the flow of liquid gas droplets 10a in the inner space 6d of the condenser 6 and/or by the arrangement and configuration of the high-pressure heat exchanger 13 in the inner space 6d of the condenser 6. Moreover, the temperature of the liquid droplets 10a sprayed into the inner space 6d, and/or the temperature difference of the introduced boil-off gas F2 and liquid droplets 10a can be influenced by the use and skillful arrangement and design of a heat exchanger 8 shown in FIGS. 2 to 5. Therefore, based on the idea of the invention disclosed herewith, it is possible for a person skilled in the art, on the basis of his expertise, to select process parameters in a simple manner in such a way that the fuel gas supply system can be operated in an economically advantageous manner, and in particular in an energy-efficient manner, and that in particular the condensation process taking place in the condenser 6 has a high condensation rate.

In a further embodiment, FIG. 3 shows a gas storage tank 14 which is connected to the gas lines 15a, 15c via controllable valves 25d, 25e. This gas storage tank 14 is used to hold boil-off gas F2, in particular during periods of time during which the high-pressure gas injection engine 2 does not require fuel, for example because the merchant ship is stationary. During such a period of time, no high-pressure liquid gas is supplied to the high-pressure gas injection engine 2, so that the high-pressure liquid gas in the heat exchanger 13 in the condenser 6 cannot serve as a heat sink, and therefore no cooling takes place in the condenser 6, so that condensation in the condenser 6 comes to a standstill. However, during the standstill of the merchant vessel, evaporated gas F2 still accumulates in the LNG tank 3, which must be discharged from the LNG tank 3 in order to prevent an impermissible pressure increase in the LNG tank 3. The gas storage tank 14 is particularly advantageous during such time periods because the boil-off gas F2 can be conveyed to the gas storage tank 14 via the compressor 9, can be temporarily stored therein, and can subsequently be removed from the gas storage tank 14 and liquefied in the condenser 6 during a voyage of the merchant vessel, or during the supply of high-pressure liquefied gas to the high-pressure gas injection engine 2.

The gas storage container 14 is advantageously filled with a highly porous solid (e.g. adsorbent or metal hydride) or a liquid solvent, which considerably increases the storage capacity of the gas storage container 14, compared to that of an empty container, at the same pressure and temperature. When the gas storage tank 14 is not in storage operation or is being emptied, the gas storage tank 14 is connected to the suction line 15b of the compressor 9 by opening the valve 25d and closing the valve 25e. When the gas storage tank 14 is in storage mode, it is connected to the discharge line 15c downstream of the compressor 9 by the valve 25e being open, and the valve 25d being closed. It may also prove advantageous to supply at least part of the boil-off gas F2 to a low-pressure consumer 11 via a fluid line 15e, preferably a controllable valve 25c and preferably also a controllable valve 25b being provided to control the flow of gas to the low-pressure consumer 11 and, if necessary, to control a division of the gas quantities between the condenser 6 and the low-pressure consumer 11.

It may also prove advantageous to feed the liquid gas F1 flowing out of the inner space 6d of the condenser 6 via the return line 21 controllably via a valve 25f of the high-pressure pump 5 and/or via a valve 25g to the LNG tank 3.

FIG. 4 shows a further embodiment of a fuel gas supply system 1, in which the boil-off gas F2 is fed to the heat exchanger 8 downstream of the tank 3, is then compressed in the compressor 9 to form compressed boil-off gas F2, this compressed boil-off gas F2 being fed in turn to the heat exchanger 8, so that the compressed boil-off gas F2 is strongly cooled in the heat exchanger 8, and, cooled in this way, is fed via the inlet 15d to the condenser 6. This compressed and strongly cooled exhaust steam gas F2 has the advantage that in the condenser 6 this exhaust steam gas F2 condenses better or more simply and thus more energy-efficiently.

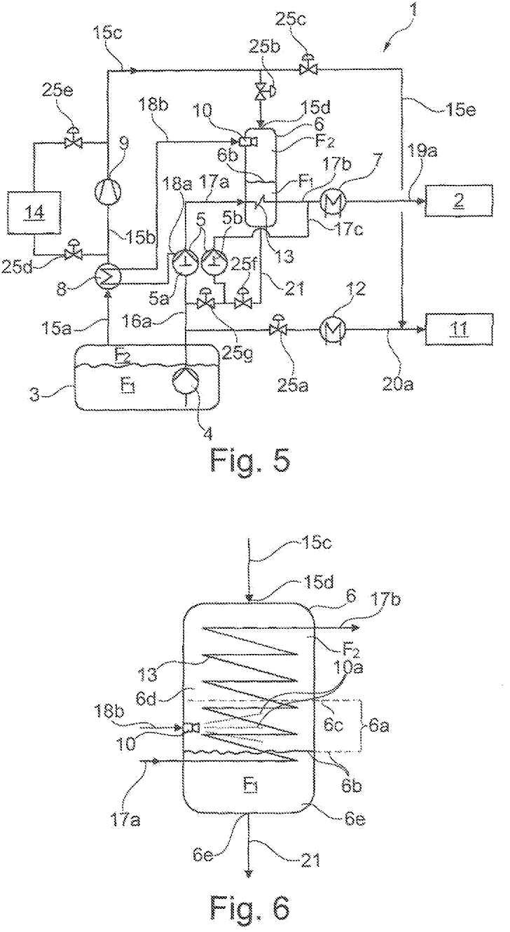

FIG. 5 shows a further embodiment of a fuel gas supply system 1 which, in contrast to the embodiment shown in FIG. 3, has two separate high-pressure pumps 5, namely a first high-pressure pump 5a and a second high-pressure pump 5b, and two separate high-pressure fluid lines 17a, 17c connected thereto. In addition, the embodiment example according to FIG. 5, in contrast to the embodiment example according to FIG. 3, has no valve 25g in the return line 21, and thus no return to the tank 3. The embodiment according to FIG. 5 is preferably operated in such a way that liquid gas F1 from the tank 3 is supplied only to the first high-pressure pump 5a and is compressed in the first high-pressure pump 5a to form high-pressure liquid gas. This high-pressure liquid gas is fed to the high-pressure heat exchanger 13 and then to the high-pressure evaporator 7, as shown in FIG. 5. In an advantageous process, the liquid gas F1, essentially a condensate, located in the condenser 6 is fed to the second high-pressure pump 5b and compressed in the second high-pressure pump 5b into high-pressure liquid gas, which, bypassing the condenser 6, is fed into the high-pressure fluid line 17b and/or directly into the high-pressure evaporator 7. This arrangement or process has the advantage that the liquid gas F1 discharged from the tank 3 is not heated by condensate or liquid gas F1 generated in the condenser 6, and liquid gas F1 fed back into the low-pressure fluid line 16a. Therefore, this embodiment has the advantage that the condensation in the condenser 6 has a higher efficiency or efficiency factor. In another possible method, the second high-pressure pump 5b can either be supplied only with condensate or liquid gas F1 from the condenser 6 via the valve 25f, or can be supplied only with liquid gas F1 from the tank 3 via the valve 25g, or can comprise a mixture comprising a proportion of liquid gas F1 from the condenser 6 and a proportion of liquid gas F1 from the tank 3 by controlling both valves 25f, 25g accordingly. The mixing ratio of these two portions of liquid gas F1 can be varied, depending on the respective operating point of the fuel gas supply system 1, for example in order to optimize the efficiency of the fuel gas supply system 1, for example depending on the amount of high-pressure fuel gas requested by the high-pressure gas injection engine 2.

1-19. (canceled)

20. A fuel gas supply system for supplying a high-pressure gas injection engine with gas stored in a liquefied gas tank,
comprising a liquefied gas tank and a high-pressure pump which can be connected in a fluid-conducting manner to the liquefied gas tank in order to supply liquefied gas from the liquefied gas tank and to compress it to a high-pressure liquefied gas,
comprising a condenser in which a high-pressure heat exchanger is arranged,
comprising a high-pressure evaporator which is fluid-conductively connected to the high-pressure pump via the high-pressure heat exchanger and is arranged downstream of the condenser, wherein the high-pressure evaporator converts the high-pressure liquid gas into a high-pressure fuel gas, and the high-pressure fuel gas is supplied to the high-pressure gas injection engine downstream of the high-pressure evaporator,
comprising a compressor which is fluid-conductively connectable to the liquid gas tank to supply boil-off gas from the liquefied gas tank, the compressor being fluid-conductively connected downstream via an inlet to an inner space of the condenser to introduce the boil-off gas into the inner space, and
comprising a condensation core generator fluid-conductively connected upstream to the high-pressure pump, wherein the condensation core generator is configured such in that it generates liquid gas droplets from the high-pressure liquid gas, which droplets serve as condensation nuclei, the condensation nucleus generator introducing the condensation nuclei into the inner space in order to promote condensation of the introduced boil-off gas via the condensation cores, so that liquefied gas is formed therefrom, and in that the liquefied gas formed in the condenser is fed to the high-pressure pump and/or to the liquefied gas tank.

21. The fuel gas supply system according to claim 20, wherein a second heat exchanger is arranged upstream of the compressor, which exchanges heat with the supplied boil-off gas, and wherein the condensation core generator is fluid-conductively connected upstream to the second heat exchanger and subsequently to the high-pressure pump in order for the second heat exchanger to exchange heat with the supplied high-pressure liquid gas.

22. The fuel gas supply system according to claim 20, wherein a second heat exchanger is arranged upstream of the compressor, which exchanges heat with the supplied boil-off gas, and wherein the compressor is fluid-conductively connected upstream in turn to the second heat exchanger in order for the second heat exchanger to exchange heat with the boil-off gas compressed by the compressor.

23. The fuel gas supply system according to claim 20, wherein the inlet of the boil-off gas is from above into the condenser, that the high-pressure heat exchanger extends in vertical direction inside the condenser, and wherein the high-pressure heat exchanger is arranged in such a way that the high-pressure liquid gas flows in the high-pressure heat exchanger from bottom to top.

24. The fuel gas supply system according to claim 20, wherein the condensation core generator has at least one high-pressure nozzle.

25. The fuel gas supply system according to claim 20, wherein the condensation core generator is arranged such that condensation cores generated by the condensation core generator are introduced into a condensation section in the inner space of the condenser in which the inner space has a condensation temperature.

26. The fuel gas supply system according to claim 25, wherein the condensation core generator is arranged in such a way that the condensation cores enter the inner space of the condenser, in the flow direction of the liquid gas, in a first half of the cooling line of the high-pressure heat exchanger.

27. The fuel gas supply system according to claim 20, wherein a storage tank for intermediate storage of boil-off gas is arranged downstream of the liquefied gas tank.

28. The fuel gas supply system according to claim 20, wherein the high pressure pump comprises at least a first high pressure pump and a second high pressure pump, wherein the first high-pressure pump is fluid-conductively connected to the condensation core generator and fluid-conductively connected to the high-pressure evaporator via the high-pressure heat exchanger, and wherein the second high-pressure pump is fluid-conductively connected to the high-pressure evaporator, bypassing the high-pressure heat exchanger.

29. The fuel gas supply system according to claim 28, wherein the first high-pressure pump is fluid-conductively connected to the liquefied gas tank to supply liquefied gas, and the second high-pressure pump is fluid-conductively connected to an outlet of the condenser to supply liquefied gas accumulated in the condenser to the second high-pressure pump.

30. The fuel gas supply system according to claim 29, wherein the second high-pressure pump is both fluid-conductingly connected to the outlet of the condenser and fluid-conductingly connected to the liquefied gas tank, wherein valves are provided to control the portion of liquefied gas supplied from the condenser and the portion of liquefied gas supplied from the liquefied gas tank.

31. A method for supplying a high-pressure gas injection engine with gas which is stored in a liquefied gas tank, partly as liquefied gas and partly as evaporated gas,
comprising the steps of feeding the liquefied gas from the liquefied gas tank to a high-pressure pump and compressing the liquefied gas by the latter to a high-pressure liquefied gas,
then feeding the high-pressure liquid gas to a high-pressure heat exchanger arranged in a condenser and subsequently to a high-pressure evaporator,
converting the high-pressure liquid gas in the high-pressure evaporator into a high-pressure fuel gas, so that a fuel gas under high pressure is produced which is fed to the high-pressure gas injection engine by feeding the boil-off gas from the liquefied gas tank to a compressor and then introducing it into the condenser,
generating a stream of condensation nuclei in the form of liquefied gas droplets in a condensation nucleus generator from high-pressure liquefied gas, which nuclei are fed in the condenser to the introduced boil-off gas in order to promote condensation of the boil-off gas to liquefied gas by the liquefied gas droplets, and
feeding the liquefied gas formed in the condenser to the high-pressure pump and/or to the liquefied gas tank.

32. The method according to claim 31, wherein the stream of condensation nuclei in the form of liquid gas droplets generated in the condensation nucleus generator, which is fed in the condenser to the introduced boil-off gas, has a mass flow rate of 1 to 5%, based on the mass flow rate of the gas to be condensed.

33. The method according to claim 31, wherein in the condenser the liquid gas is conveyed from the bottom to the top in the high-pressure heat exchanger, and wherein the boil-off gas is conveyed in the condenser in counterflow from the top to the bottom.

34. The method according to claim 31, wherein a condensation section is generated in the inner space of the condenser, within which the boil-off gas has a temperature which is below the boiling temperature of the liquid gas, and wherein condensation nuclei in the form of supercooled liquid gas droplets are sprayed into this condensation section.

35. The method according to claim 34, wherein a temperature of -140° C. to -80° C. and a pressure of 5 to 30 bara are present in the generated condensation section.

36. The method according to claim 31, wherein a side stream of high-pressure liquid gas is withdrawn from or downstream of the high-pressure pump, wherein this side stream is cooled in a heat exchanger, wherein boil-off gas discharged from the liquefied gas tank is simultaneously heated in the heat exchanger, wherein the boil-off gas is fed to the condenser downstream of the heat exchanger, and wherein the high-pressure liquefied gas is fed to the condensation core generator downstream of the heat exchanger.

37. The method according to claim 31, wherein the high-pressure liquid gas is compressed to a pressure in the range between 150 bara and 400 bara.

38. A merchant vessel comprising a fuel gas supply system according to claim 20.
